(19) United States
(12) Patent Application Publication
(10) Pub. No.: US 2020/0305398 A1
(43) Pub. Date: Oct. 1, 2020

(54) Aquaponics Apparatus

(71) Applicant: Aquaponos, LLC, Chandler, AZ (US)

(72) Inventors: Chandler Petrovich Flynn, Chandler, AZ (US); Veronica Head, Springville, PA (US); Nicholas Kandas, Scottsdale, AZ (US)

(21) Appl. No.: 16/366,892

(22) Filed: Mar. 27, 2019

(51) Int. Cl. A01K 63/00; A01K 63/04

(52) U.S. Cl. CPC A01K 63/003; A01G 31/02; A01K 63/04

(57) ABSTRACT

A vertically oriented aquaponics stand having a basin, a frame, and a grow bed.

### FIELD OF THE INVENTION

The present invention relates to aquaponics and more particularly to an apparatus or structure to accommodate an aquaponics installation or instance.

### SUMMARY OF THE INVENTION

An aquaponics stand or construction may be comprised of a basin, a frame and a grow bed. The stand may be assembled and water added to the basin along with a chosen edible aquaponics species and edible plantings in the grow bed. Water from the basin, with accumulated fish waste, is pumped to the grow bed to fertilize the edible plantings.

In certain embodiments the frame comprises a frame base, at least one frame vertical support, and a frame tray. The at least one frame vertical support may be coupled from the frame base to the frame tray and the grow bed may sit on the frame tray. The basin and grow bed may be ring shaped and have a first cylindrical diameter greater than the frame tray inside diameter and the grow bed may have a funnel shaped end with a smaller diameter than the frame tray inside diameter. The stand may be sized for a small educational desktop instance or scaled upward for a commercial or practical application.

Numerous other advantages and features of the present invention will become readily apparent from the following detailed description of the invention and the embodiments thereof, from the claims and from the accompanying drawings.

### BRIEF DESCRIPTION OF THE FIGURES

The objects, features and advantages of the present invention will be more readily appreciated upon reference to the following disclosure when considered in conjunction with the accompanying drawings, wherein reference numerals are used to identify the components in the various views.

FIG. 1 illustrates a side view of an embodiment of the stand used in an aquaponics instance;

FIG. 2 illustrates an exploded view of the embodiment and instance;

FIG. 3 illustrates a top view of the embodiment;

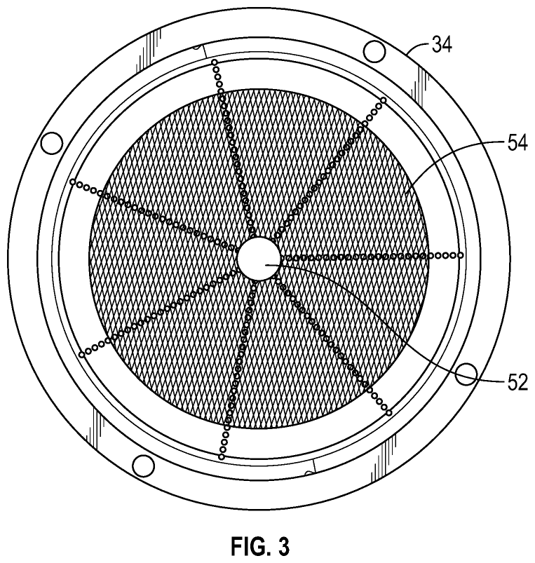

FIG. 4 illustrates an elevated side perspective of the embodiment;

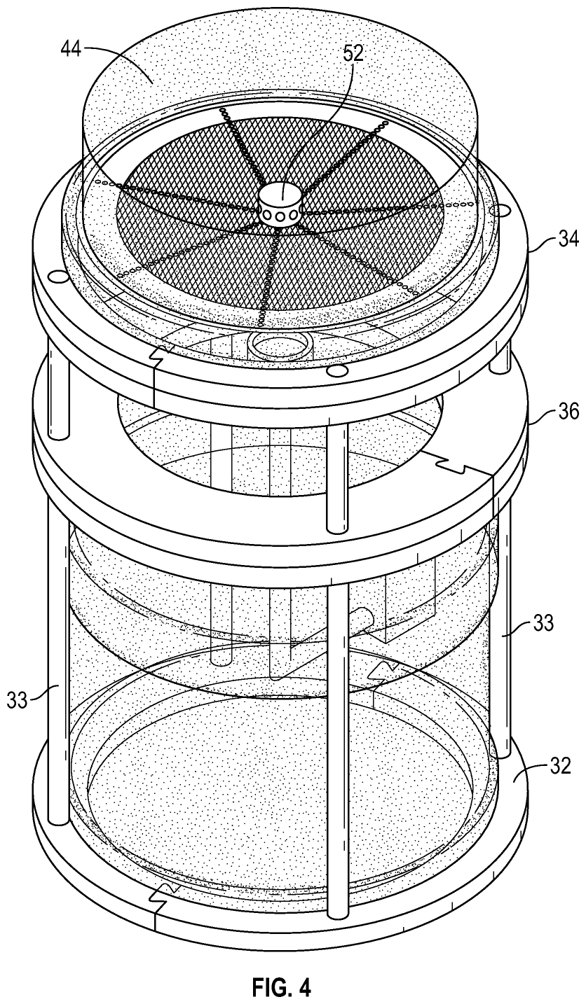

FIG. 5 illustrates a side view of the stand without a basin 20 and grow bed 40; and

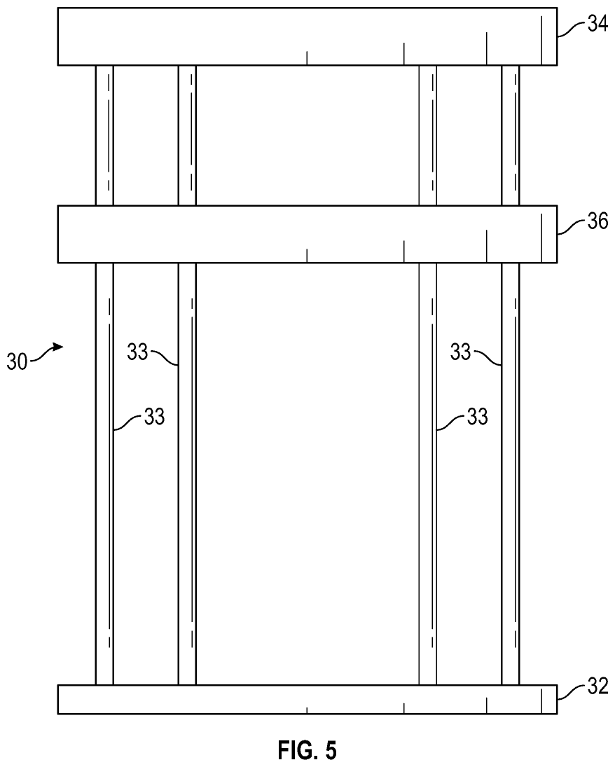

FIG. 6 illustrates a side elevated exploded view showing an assembly of the frame 30 and the components thereof.

### DESCRIPTION OF PREFERRED EMBODIMENTS

The invention or features thereof described herein is or are adaptable to embodiments having many different forms and functions related to the disclosure herein. The embodiment shown in the drawings and will be described herein in detail with the understanding that the present disclosure is to be considered as an exemplification of the principles of the invention and is not intended to limit the invention to the specific embodiment(s) illustrated. Embodiments consistent with the present invention may be alternately embodied, practiced, and/or carried out in various ways or implementations. Also, it is to be understood that the phraseology and terminology employed herein, as well as the abstract included below, are for the purposes of description and should not be regarded as limiting. Reference throughout this specification to “embodiment” should inform a person having ordinary skill that a particular feature, structure, or characteristic described in connection with the embodiment is included in at least one embodiment of the present invention but not necessarily in all embodiments. The features, structures, or characteristics of any embodiment of the present invention may be combined in any suitable manner and in any suitable combination with one or more other embodiments, including the use of selected features without corresponding use of other features. Modifications may be made to adapt an implementation of certain features to the essential scope and spirit of the present invention and certain features, limitations, or elements of each embodiment can be omitted or replaced with equivalents. It should be understood that other variations and modifications of the embodiments of the present invention described and illustrated herein are possible and part of the spirit and scope of the present invention. Finally, the disjunctive term “or” herein, is generally intended to mean “and/or”, having both conjunctive and disjunctive meanings (i.e. not an “exclusive or” meaning), unless so indicated. And, as used in the description herein and throughout the claims that follow, “a”, “an”, and “the” should be interpreted as “at least one” and include plural references unless the context dictates otherwise.

Embodiments of a stand or structure according to the disclosure are particularly well suited to an aquaponics application or instance. Moreover, the stand is scalable depending on the size of the aquaponics instance or application. In general, the embodiment is comprised of a basin 20, a frame 30, and a grow bed 40. In preferred embodiments, the basin 20 is substantially cylindrically shaped with a closed-end, a basin side wall, and a basin top edge or basin rim at or around the periphery of the basin open-end. Similarly, the grow bed 40 is also preferably cylindrically shaped and funnel shaped wherein the diameter of the grow bed 40 is smaller at the grow bed drain 46 than at grow bed side wall 44 that terminates at the the basin top edge or basin rim. A preferred frame 30 may be comprised of a frame base 32, at least one frame vertical support 33, and a frame tray 34. The frame base 32 may be positioned at or around, the basin 20, which when filled with water and fish can provide ballast for the frame 30. The at least one frame vertical support 33 is coupled between the frame base 32 and the frame tray 34 and vertically supports the vertical position of the frame tray 34 with the basin 20 positioned beneath the frame tray 34. A grow bed 40 is positioned or seated on the frame tray 34 and is in two-way fluid communication with the basin 20.

The frame tray 34 may be substantially ovular, ring, or collar shaped with an interior rim width or span. In preferred embodiments, the frame tray 34 is substantially ring shaped and the grow bed drain 46 has a funnel shape with first drain width that is smaller than the frame tray 34 interior rim span, and a second drain width that is larger than the frame tray 34 interior rim span.

Accordingly, the outside lower surface of the grow bed 40 will sit or rest on and against the interior rim of the frame tray 34 with the first drain width received through and positioned on one side of the frame tray 34 and the second drain width seated on or against a second side of the frame tray 34. Moreover, the frame base 32 and frame tray 34 may each be substantially ring shaped and have substantially the same outside diameter, but the frame tray 34 may have a smaller effective interior span to prevent the grow bed drain 46 from falling through the frame tray 34.

The at least one frame vertical support 33 is coupled between the frame base 32 and frame tray 34. The at least one frame vertical support 33 may comprise a rod with a first end that is received by and seated in (or extends through) the frame base 32, a second end that extends to and is received by the frame tray 34. In preferred embodiments, a plurality of frame vertical supports 33 are distributed around the periphery of the basin 20 and each support 33 extends substantially parallel to the other supports 33 and couples the frame base 32 to the frame tray 34. As illustrated, the frame 30 may also include a ring or collar shaped middle frame support 36 that may be seated on the basin top edge 24 and oriented substantially parallel to and between the frame base 32 and the frame tray 34. Finally, the grow bed 40 is preferably substantially funnel shaped and has a grow bed side wall 44 that transitions to a grow bed drain 46. A grow-medium such as clay pebbles are placed in the grow bed 40 and living plants are seated in the grow-medium. Water from the basin 20, fertilized by the fish waste is then pumped to the grow bed 40 to feed and water the plants.

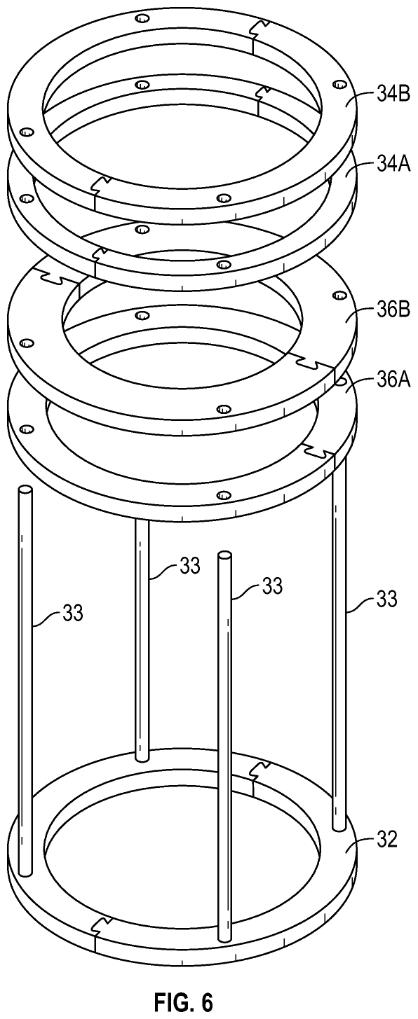

An exemplary preferred embodiment is illustrated in the figures. The basin 20 and the grow bed 40 are formed from a five gallon water jug that is cut perpendicularly to the longest dimension of the jug. The bottom end of the water jug comprises the basin 20 and the spout or opening of the five gallon water jug comprises the grow bed drain 46, which is inverted and seated on the frame tray 34. It follows that the basin 20 and grow bed 40 each have a cylindrically shaped cross section and have a common diameter at the widest portions. Moreover, it is preferred that the jug be cut at more than 50% of the length of the five gallon water jug cylinder so that the basin side 23 is longer than the grow bed side wall 44. The frame base 32 and frame tray 34 may each be substantially collar or ring shaped and a plurality of frame vertical supports 33 may couple the frame base 32 to the frame tray 34 with the ring shaped middle frame support 36 positioned between the frame base 32 and frame tray 34 and seated on the basin top edge 24. Further, any of the ring shaped frame 30 components may be assembled from one or more rings as illustrated in FIG. 6 and facilitate differing interior diameters or ring interior rim spans. As an example, the frame tray 34 may comprise a frame tray first ring 34A having a first diameter and a frame tray second ring 34B having a second diameter different than the frame tray first ring 34A first diameter. Alternately (or additionally), the middle frame support 36 may comprise a middle frame support first ring 36A having a first diameter and a middle frame support second ring 36B second diameter that is different than the middle frame support first ring 36A first diameter. Finally, the frame 30 components may be comprised of any material capable of supporting the weight of the aquaponics instance, including woods, plastics, and metals.

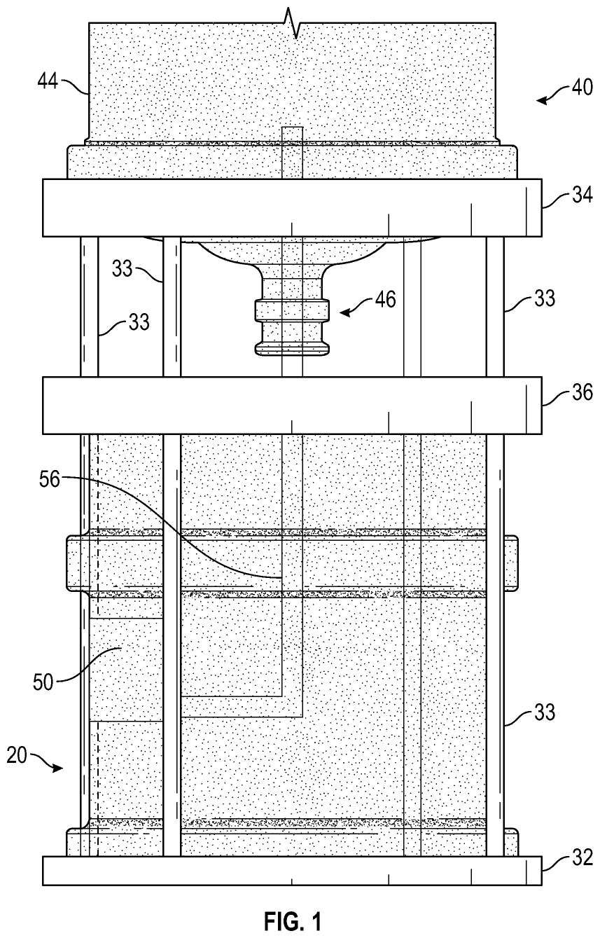

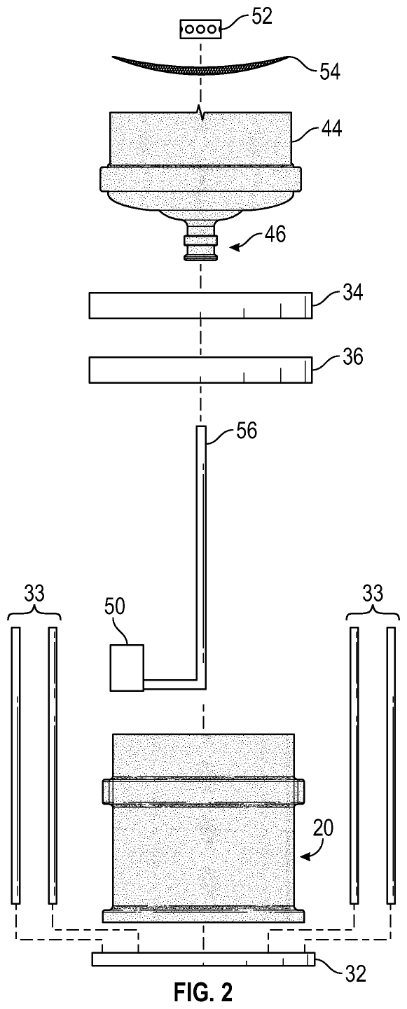

The basin 20 and grow bed 40 are in two-way fluid communication. A first-way of communication comprises fluid flowing from the grow bed 40 and through the grow bed drain 46 to the basin 20. A second-way of communication comprises fluid pumped through a tube 56 connectable to a pump 50 positioned in the basin 20 and fed upward through the grow bed drain 46 into the grow bed 40. See FIGS. 1 and 2. As previously described, water from the basin 20 is pumped to the grow bed 40 and applied to the soil or grow medium in the grow bed 40. The clay pebbles may be placed on top of a screen or mesh 54 to prevent the medium from falling through the grow bed drain 46 and a diffuser 52 may be connected to the tube end in the grow bed 40 to more evenly disperse water pumped from the basin 20.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents and all such modifications that fall within the scope of the claims.

1. An apparatus, comprising:
a basin comprised of a basin side, and a basin top edge;
a frame comprised of a frame base, at least one frame vertical support, a frame tray, the frame vertical support coupled between the frame base and the frame tray, the basin positioned substantially beneath the frame tray; and
a substantially funnel shaped grow bed, comprised of a grow bed side wall and a grow bed drain, the grow bed positioned on the frame tray and in two-way fluid communication with the basin.

2. The apparatus in claim 1 wherein,
the basin is substantially cylindrically shaped and the basin side and basin top edge are positioned substantially beneath the frame tray.

3. The apparatus in claim 2 wherein,
a middle frame support is seated on the basin top edge and oriented substantially parallel to and between the frame base and the frame tray.

4. The apparatus in claim 1 wherein,
the frame tray is substantially ring shaped with an interior rim span, the grow bed drain has a first drain width smaller than the interior rim span and a second drain width larger than the interior rim span.

5. The apparatus in claim 4 wherein,
the first drain width smaller is positioned on one side of the frame tray and the second drain width positioned on a second side of the frame tray.

6. The apparatus in claim 1 wherein,
the frame base and frame tray are each substantially ring shaped.

7. The apparatus in claim 6 wherein,
the frame base and frame tray have different interior rim spans but substantially the same outside diameters.

8. The apparatus in claim 1 further comprising,
a middle frame support positioned substantially parallel to and between the frame base and frame tray.

9. The apparatus in claim 8 wherein,
the at least one frame vertical support is coupled between the frame base, the middle frame support, and the frame tray.

10. The apparatus in claim 1 wherein,
a plurality of frame vertical supports are coupled between the frame base and frame tray.

11. The apparatus in claim 1 wherein,
the basin and grow bed comprise a closed-end portion and a spout portion of a five gallon jug cut perpendicularly to the longest dimension of the jug.

12. An apparatus, comprising:
a substantially ring shaped frame base having a frame base diameter, a substantially ring shaped frame tray having a frame tray diameter, the frame base and frame tray oriented substantially parallel, and at least one frame vertical support coupled between the frame base and the frame tray;
a substantially cylindrically shaped basin dimensioned to fit within the frame base diameter; and
a funnel shaped grow bed with a grow bed drain first end having a diameter smaller than the frame tray diameter and a grow bed second end having a diameter larger than the frame tray diameter, the grow bed seated on the frame tray;
wherein the grow bed and the basin are in two way fluid communication.

13. The apparatus in claim 12 wherein,
the basin has a basin top edge, and
a substantially ring shaped middle frame support is seated on the basin top edge and oriented substantially parallel to and between the frame base and the frame tray.

14. The apparatus in claim 13 wherein,
the middle frame support secures the at least one frame vertical support in a vertical position.

15. The apparatus in claim 14 wherein,
a plurality of frame vertical supports are coupled between the frame base, the middle frame support, and the frame tray.

16. The apparatus in claim 12 wherein,
the basin and grow bed comprise a closed-end portion and a spout portion of a five gallon jug cut perpendicularly to the longest dimension of the jug.
